(19) United States
(12) Patent Application Publication
(10) Pub. No.: US 2004/0231443 A1
(43) Pub. Date: Nov. 25, 2004

(54) Clutch slip control device and method

(75) Inventors: Martin Vornehm, Buhl (DE); Mario Jung, Sinzheim (DE); Oliver Amendt, Renningen (DE); Bernhard Boll, Alling (DE)

Correspondence Address: Robert P. Simpson, Esq., Simpson & Simpson, PLLC, 5555 Main Street, Williamsville, NY, 14221-5406, US

(73) Assignee: LuK Lamellen und Kupplungsbau Beteiligungs KG, Buhl (DE)

(21) Appl. No.: 10/762,946

(22) Filed: Jan. 22, 2004

(30) Foreign Application Priority Data
Jul. 18, 2002 (WO) PCT/DE02/02650
Jul. 23, 2001 (DE) 101 35 860.1

(51) Int. Cl. F16H 59/00; F16H 61/00

(52) U.S. Cl. 74/335

(57) ABSTRACT

A device for an automatic clutch in motor vehicles, provided with hydraulic transmitter pickup actuator arrangements and a compensation system for a hydraulic fluid. In a cylinder, a modulation limit of a piston is defined, whereby the piston cup thereof in said position comes to rest outside an opening of the compensation system disposed in the wall of the cylinder.

### CROSS-REFERENCE TO RELATED APPLICATION

This patent claims the benefit under 35, U.S.C. § 120 and § 365(c) of International Patent Application PCT/DE02/02650, filed Jul. 18, 2002 and published Feb. 27, 2003, and incorporated by reference herein. This patent also claims priority of German Patent Application No. 101 35 860.1, filed Jul. 23, 2001, which application is incorporated herein by reference.

### BACKGROUND OF THE INVENTION

The invention relates to a clutch slip control device in a clutch assembly that comprises a clutch actuation assembly made up of a transmitter cylinder/piston assembly and pickup cylinder/piston assembly, which are hydraulically joined to each other via an opening in the wall of the transmitter cylinder, the opening being connected to a compensating reservoir that contains the same hydraulic fluid as in the cylinders of the assemblies, having means for the detection of the rotational speed of a clutch input and output shaft, a coupling component, which is connected at one end to the piston of the pickup cylinder of the assembly and at the other end to a moving clutch part of the clutch, and a clutch slip control method.

Motor vehicles having an automated clutch disposed within the flow of torque between internal combustion engine and fixed-ratio manual shift transmission and at least one shift or control device or gear controller for this purpose, known under the designation “electronic clutch management” are described in DE-OS 40 11 850.

Control methods of the type mentioned are described in detail, for example, in German Patent 44 26 260 A1 and German Patent 198 57 707. The published content of these documents is a component of the present invention.

Both documents disclose in FIGS. 1 to 3 or 2 and 5 assemblies of hydraulic system components having transmitter cylinder/piston and pickup cylinder/piston assemblies along with the hydraulic lines that join them and a reservoir for the hydraulic fluid by which hydraulic fluid can be exchanged with its inner chamber through an opening in the perimeter of the transmitter cylinder. A piston is disposed in the transmitter cylinder in such a manner as to be movable back and forth. The piston has a seal on the perimeter that seals a primary chamber off from a secondary chamber, these chambers being located, respectively, in front of and behind the piston. In this context, “in front of” is intended to mean “in the clutch-disengaged direction” and “behind” in the opposite direction. If the piston is positioned behind the opening, a volume compensation of the hydraulic fluid, which is called snifting, can be carried out through the opening. To operate the clutch, the piston is moved back and forth within the area that is situated in front of the opening.

The known methods and devices nevertheless have the following disadvantage: because the hydraulic fluid expands or contracts as a function of temperature, the position of the piston at which the hydraulic fluid is under a certain pressure is not always constant. In order to deal with this change, the pistons are run at regular intervals or as needed in such a manner that the opening and a compensating reservoir, which is filled with hydraulic fluid and joined to the opening, are brought into connection with the primary chamber in which the hydraulic fluid is located so that a volume compensation (snifting) can occur and then a specific piston position corresponds again to the appropriate pressure. Frequent “snifting” nevertheless requires that the piston run past the opening numerous times, which results in the seal around the perimeter of the piston frequently being moved back and forth past the usually sharp edges of the opening and, as a result, being subject to increased mechanical wear, which can lead to a shortened service life of the seal and thus to premature failure of the clutch. Moreover, running past the opening can result in jerky engagement, which the driver may sense as unpleasant.

### OBJECT OF THE INVENTION

With respect to this state of the art, the object of the invention is to further develop a device and a method for clutch slip control in such a manner that a jerky engagement is prevented and the service life of the transmitter cylinder/piston assembly is increased.

### BRIEF SUMMARY OF THE INVENTION

This objective is achieved in accordance with the invention by a device of the type mentioned at the outset in such a manner that a drive device comprises an electronically programmable control unit and an electric motor along with a transmission that is mechanically connected to the piston of the transmitter cylinder and that the means feed the detected rotational speeds into the control unit that drives the electric motor.

In another embodiment of the invention, a transmission converts a rotary movement induced by the electrical motor via a shaft into a linear movement having two different speeds at which the piston can be impinged.

In a further development of the device, the piston is positionable in areas of the transmitter cylinder and there is a modulation limit in the transmitter cylinder that is disposed in front of the opening in the direction of the piston's movement toward clutch engagement. Additional embodiments of the device arise from the features of patent claims 4 to 9.

The method for clutch slip control is characterized in that a pre-selectable modulation limit of the piston is determined at which a seal of the piston on the side facing a primary chamber is positioned outside of an opening for the feeding and draining of hydraulic fluid inside or outside the hydraulic cylinder and does not touch the edge of the opening, in that when the piston reaches the modulation limit there is a detection of whether the difference between the rotational speed of the input shaft and the output shaft is greater than or equal to a pre-determinable value, and in that, if there is a difference in the speeds that is not equal to zero, the piston is moved at a first pre-determinable low speed into a first position in which the seal on the side facing a secondary chamber is positioned outside the opening and then is moved at a second, greater pre-determinable speed further in the first direction.

Additional embodiments of the method of the invention are described in patent claims 11 to 17.

### BRIEF DESCRIPTION OF THE DRAWING

The invention is explained below in relation to the schematic diagram of FIG. 1 using examples, but this is in no way intended as a limitation of the invention.

FIG. 1 is a schematic diagram of the present invention.

### DETAILED DESCRIPTION OF THE PREFERRED EMBODIMENT

In a hydraulic transmitter/pickup cylinder system, it may be occasionally necessary to carry out a volume compensation because the hydraulic fluid expands as a function of temperature and, as a result, the position of the transmitter cylinder does not necessarily correspond to the position of the pickup cylinder. For this purpose there is an opening, the snifting hole, preferably in the transmitter cylinder, that opens a fluid connection between the transmitter/pickup cylinders system and a compensating reservoir. This is carried out at regular points in time or in certain operational situations of a vehicle so that it can be guaranteed that a certain relationship is ensured as much as possible between the transmitter cylinder position and the pickup cylinder position during the entire time the vehicle is in operation.

Now, in running past the snifting hole, there are problems with the seal disposed on the transmitter cylinder/piston because the snifting hole, for example, can have an area with sharp edges and the seal would possibly be damaged if positioning movements passed the snifting hole that changed in direction, that is back and forth movements, were to be continually triggered.

For this reason a modulation limit is defined for the movement of the transmitter cylinder/piston, below which a back and forth movement of the transmitter cylinder/piston is permitted without a problem, and, after exceeding the modulation limit of the transmitter cylinder/piston, only movement in one direction is permitted before the change in direction may be carried out in an end region clearly behind the snifting hole. Thus, the modulation limit defines a position within the transmitter cylinder that is used in the software as a limit value so that the seal of the transmitter cylinder/piston is not too heavily strained in the region of the snifting hole by a change in direction.

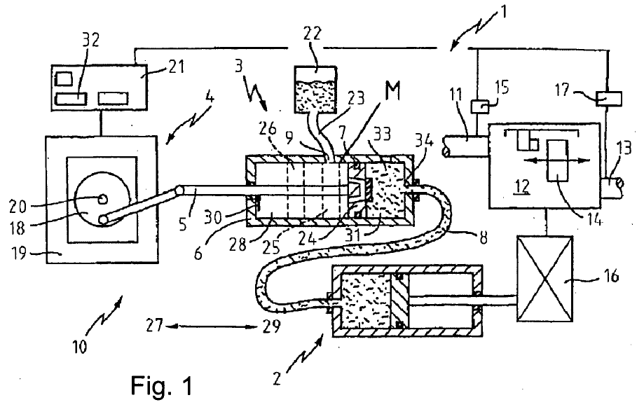

The single FIG. 1 schematically shows a clutch assembly 1 in partial view. Clutch assembly 1 comprises a clutch actuation assembly 10 and a clutch 12. Clutch 12, which is actuated or driven by clutch actuation assembly 10, has a device (not shown) by which different engagement intensities of clutch 12 may be set. The value of the torque that is transferable from a clutch input shaft 11, for example, an engine output shaft, to a clutch output shaft 13, for example, a transmission input shaft, is a function of this engagement intensity.

If no positioning signal from clutch actuation assembly 10 acts on clutch 12, it is in a state of maximum engagement intensity, which may be achieved via a known spring assembly (not shown). At least one schematically depicted clutch component 14 is arranged so as to be movable. Clutch actuation assembly 10 is joined to clutch 12 via a coupling component 16. This coupling component 16 is joined to a hydraulic assembly, which comprises a pickup cylinder/piston assembly 2, a connecting device in the form of a connection hose 8 and a transmitter cylinder/piston assembly 3. Transmitter cylinder assembly 3 includes a transmitter cylinder 6 in which a piston 5 is disposed so as to be movable. It is actuated by a drive device 4 that has an electronic, programmable control unit 21. The directions in which piston 5 must be moved in order to effect an engagement or disengagement of the clutch are indicated, respectively, by arrows 27 and 29. Drive device 4 also includes a transmission, which converts a rotary movement induced by an electric motor 19 via a shaft 20 in transmission 18 into a linear movement having varying speeds at which piston 5 is impinged. The position of piston 5 in cylinder 6 is detectable via the angular position of transmission 18. Other means for position detection are disclosed in German Patent 4 426 250 A1. Moreover, control unit 21 is still connected to the gearshift of the motor vehicle so that each gear of the transmission that is engaged, or the intention of the vehicle driver to engage a certain gear, is detectable.

Cylinder 6 has an opening 9, a so-called snifting hole, by which a flow connection exists between the interior of cylinder 6 and a compensating reservoir 22 via a line 23. Opening 9 defines three essentially different areas 24, 25, 26 for piston 5. The piston positions in these areas are indicated by broken lines; likewise a modulation limit M. In first area 24, piston 5 is disposed inside cylinder 6 between opening 9 and clutch-side end 34 of cylinder 6 in such a manner that a flow connection may be produced between compensating reservoir 22 and a controller-side secondary chamber 28 in cylinder 6 if, when applicable, a corresponding drivable valve (not shown) that may be disposed in line 23 is open. In second area 25 there is no flow connection between compensating reservoir 22 and the interior of cylinder 6 because piston 5 closes off opening 9. In third area 26, piston 5 is disposed inside cylinder 6 between opening 9 and controller-side end 30 of cylinder 6 in such a manner that there is a flow connection between compensating tank 22 and a primary chamber 31, that is, a volume compensation may occur. For the detection of rotary speeds of clutch input shaft 11 and clutch output shaft 13, means 15, 17 are present and connected to control unit 21. For additional details, refer to German Patent 1 9857 707.

In a preferred embodiment, the method of the invention is carried out in the following manner: if during the normal driving operation of the motor vehicle piston 5 moving in direction 27 reaches modulation limit M, control software 32 in control unit 21 first checks whether the clutch is still slipping, that is, whether the difference between the rotational speeds of shafts 11 and 13 is not equal to zero or, preferably, is greater than a pre-determinable value. In this case, piston 5 is driven in direction 27 at a slower speed, which corresponds to a slow snifting ramp, up to opening 9 so that a seal 7 in piston 5 assumes a position behind opening 9. Then a volume compensation of a hydraulic fluid 33 between primary chamber 31 and compensating reservoir 22 occurs. Upon reaching this position, the piston is driven at maximum speed in direction 27 to engage the clutch. This is feasible because after the volume compensation no modulation of the clutch, that is, an actuation at varying speeds, is possible when running in direction 27. A reversing of the direction of piston 5 behind the modulation limit M into direction 29 is only permitted by the control software 32 if piston 5 has been driven beforehand to the end of stroke in direction 27 and the clutch was completely engaged. Only in exceptional cases, if an intention to shift torque requirement was detected, is a change in direction permitted by the control software 32, assuming that piston 5 and/or seal 7 have already run completely past opening 9. In a preferred way, piston 5 always runs past opening 9 at a pre-determinable low speed in order to ensure a constant volume compensation, which prevents an engagement kick.

For the determination of the modulation limit, the following parameters are to be considered: width of opening 9, if it must be completely opened for snifting, otherwise the indication of a minimum width suffices, and tolerance field width for the axial position of opening 9 in the cylinder wall in order to compensate manufacturing or measurement errors. The safety distance of seal 7 from opening 9, because seal 7 is not to be pressed into opening 9, corresponds to at least the width of seal 7 if piston 5 has run past opening 9 in direction 27.

Typical values are: width of opening 9 is approximately 0.4 to 0.8 mm; tolerance field width is approximately 0.8 to 2.4 mm; safety distance and width of seal 7 is 0.02 to 1 mm. Advantageously, modulation limit M has a distance of approximately 1.4 to 4.2 mm from the clutch-side edge of opening 9.

In another preferred embodiment of the invention, the first speed is low, preferably less than 5 mm/s and the second speed is high, preferably higher than 1 mm/s. Piston 5 is moved at the higher speed up to the control-side end of cylinder 6.

The advantage of the invention is essentially to be seen in the fact that a jerky engagement of the clutch is prevented. The invention therefore contributes on the one hand to a greater driving comfort and on the other hand to longer service life for the clutch because the closure of the piston seal is substantially reduced.

Regarding the electronic regulation or control devices having suitable sensors and actuation means as well as corresponding control or adjustment method for vehicles with automated clutches and shift transmissions, refer expressly to German patents 40 11 850 A1, 1 9857 707 and 197 45 677 A1 and European patent 1 010 606 A1, in this connection.

The patent claims submitted along with the application are formulation proposals without prejudice for the attainment of ongoing patent protection. The applicant reserves the right to claim additional feature combinations that so far are only disclosed in the description and/or drawings.

References used in the dependent claims point to the further formation of the subject matter of the main claim by the features of each dependent claim; they are not to be understood as renunciation of the attainment of separate, concrete protection for the feature combinations of the referred dependent claims.

Because the subject matter of the dependent claims can form separate and independent inventions with respect to the state of the art on the priority date, the applicant reserves the right to make them the subject matter of independent claims or separation statements. They may furthermore also include independent inventions that have a configuration independent of the subject matter of prior dependent claims.

The exemplary embodiments are not to be understood as a limitation of the invention. Rather, numerous amendments and modifications are possible within the context of the present publication, especially such variants, elements and combinations and/or materials that can be inferred by one skilled in the art with regard to the resolution of the problem using, for example, a combination or modification of individual features or elements or methodological steps that are described in connection with the general description and embodiments as well as the claims and are contained in the drawings and, using combinable features, lead to a new subject matter or to new methodological steps or methodological sequences, even if they pertain to manufacturing, testing and operating method.

What is claimed is:

1. A device for the slip control of a clutch in a clutch assembly that comprises a clutch actuation assembly made of a transmitter cylinder/piston assembly and a pickup cylinder/piston assembly, which are hydraulically joined to each other via an opening in the wall of the transmitter cylinder, the opening being joined to a compensating reservoir that contains the same hydraulic fluid as in the cylinders of the assemblies, having means for the detection of the rotational speed of a clutch input and output shaft, a coupling component, which is connected at one end to the piston of the pickup cylinder of the assembly and at the other end to a moving clutch part of the clutch, wherein a drive device comprises an electronically programmable controller unit and an electric motor having a transmission that is mechanically joined to the piston of the transmitter cylinder and means feed the detected rotational speeds into the controller unit that drives the electric motor.

2. The device as described in claim 1, wherein the transmission converts a rotary movement induced by the electric motor via a shaft into a linear movement at two different speeds with which the piston can be impinged.

3. The device as described in claim 1, wherein the piston is positionable in areas of the transmitter cylinder and there is a modulation limit in the transmitter cylinder, which is disposed in front of the opening in the direction of the piston movement for the engagement of the clutch.

4. The device as described in claim 2, wherein the speed of the piston in its movement in the direction toward crossing over the modulation limit is low and the speed of the piston movement increases to its maximum value after the piston has passed the opening in the direction.

5. The device as described in claim 3, wherein in the first area the piston picks up a position between the opening and a clutch-side end in the transmitter cylinder so that the compensating reservoir is connected to a controller-side secondary chamber of the transmitter cylinder.

6. The device as described in claim 3, wherein the second area covers the opening and the piston positioned within the second area closes off the opening.

7. The device as recited in claim 3, wherein the third area is disposed in the direction toward the opening and in front of a control-side end of the transmitter cylinder and, when the piston is positioned in the third area, the compensating reservoir is connected to a primary area of the transmitter cylinder.

8. The device as described in claim 3, wherein the modulation limit has a distance of 1.4 to 4.2 mm from the clutch-side edge of the opening.

9. The device as described in claim 3, wherein there is a seal in the piston that has a width of 0.2 to 1 mm and the safety distance of the seal from the opening, after the piston is driven past said opening, is at least equal to the seal width.

10. A method for slip control of a clutch that is disposed in the drive train of a motor vehicle and comprises a transmitter cylinder/piston assembly having a transmitter cylinder in which a controllable piston is longitudinally displaceable, its position in the transmitter cylinder being detected, the piston is displaced in the cylinder in a first direction to engage the clutch and in a second, opposite direction to disengage the clutch, and the rotational speeds of an input shaft and an output shaft of the clutch are detected, wherein a pre-selectable modulation limit of the piston is determined at which a seal of the piston on the side facing a primary chamber is positioned outside of an opening for the feeding or draining of hydraulic fluid inside or outside the transmitter cylinder and does not touch the edge of the opening, when the piston reaches the modulation limit, there is a detection of whether the difference between the rotational speed of the input shaft and the output shaft is greater than or equal to a pre-determinable value, and, when there is a difference of rotational speeds not equal to zero, the piston is moved at a first pre-determinable low speed into a first position in which the seal on the side facing toward a secondary chamber is positioned outside of the opening and then is moved at a second greater pre-determinable speed further in the first direction.

11. The method as described in claim 10, wherein the seal seals off the primary chamber for the hydraulic fluid from the secondary chamber and the piston is always positioned in such a manner that the seal does not come to rest in the opening.

12. The method as described in claim 10, wherein the first speed is selected to be low, preferably lower than 5 mm/s and the second speed to be high, preferably higher than 1 mm/s.

13. The method as described in claim 10, wherein the piston is moved at the second speed up to the control-side end of the cylinder.

14. The method as described in claim 10, wherein a distance of 1.4 to 4.2 mm from the edge of the opening is set for the modulation limit.

15. The method as described in claim 10, wherein, after the detection of a driver's intention to shift or of a torque requirement, a change in the direction of the piston after the modulation limit is crossed is carried out only after the piston and/or the seal have already run past the opening.

16. The method as described in claim 10, wherein a programmable electronic control unit that has inputs that can be connected to means for the detection of the rotational speeds of the input and output shafts of the transmission and/or of the intended and/or engaged gear of the transmission and outputs by which control signals are routed to an electric motor that operates a transmission, and the control unit is programmed using software and is wired to the slip control device.

17. The method as described in claim 16, wherein the position of the piston in the transmitter cylinder is detected via the angle position of the transmission.
